(19) United States
(12) Patent Application Publication
(10) Pub. No.: US 2025/0355632 A1
(43) Pub. Date: Nov. 20, 2025

(54) TEACHING ALGORITHMIC REASONING TO GENERATIVE MODELS VIA EXECUTION TRACES

(71) Applicant: QUALCOMM Incorporated, San Diego, CA (US)

(72) Inventors: Wei David ZHANG, Amsterdam (NL); Corrado RAINONE, Haarlem (NL); Michael DEFFERRARD, Chavannes-sous-Orsonnens (CH); Roland MEMISEVIC, Toronto (CA); Mingu LEE, San Diego, CA (US); Zhan LING, La Jolla, CA (US)

(21) Appl. No.: 18/883,967

(22) Filed: Sep. 12, 2024

Related U.S. Application Data
(60) Provisional application No. 63/647,505, filed on May 14, 2024.

(51) Int. Cl. G06F 8/30; G06F 9/455

(52) U.S. Cl. CPC G06F 8/30; G06F 9/45558

(57) ABSTRACT

A method includes generating, via a virtual machine, a group of code traces, each code trace of the group of code traces corresponding to a respective algorithm, of a group of algorithms, and a corresponding input. The method also includes fine-tuning a generative model in accordance with the group of code traces. The method further includes receiving, at the fine-tuned generative model, computer programming code. The method also includes generating, via the fine-tuned generative mode, one or more computer programming code statements corresponding to the computer programming code or simulate an expected output of the computer programming code.

### CROSS-REFERENCE TO RELATED APPLICATION

The present application claims the benefit of U.S. Provisional Patent Application No. 63/647,505, filed on May 14, 2024, and titled “TEACHING ALGORITHMIC REASONING TO GENERATIVE MODELS VIA EXECUTION TRACES,” the disclosure of which is expressly incorporated by reference in its entirety.

### FIELD OF THE DISCLOSURE

Aspects of the present disclosure generally relate to teaching algorithmic reasoning to generative models via execution traces.

### BACKGROUND

Artificial neural networks may comprise interconnected groups of artificial neurons (e.g., neuron models). The artificial neural network (ANN) may be a computational device or be represented as a method to be performed by a computational device. Generative models represent one type of artificial neural network. In most cases, generative models are trained on extensive datasets of pre-existing content (hereinafter referred to as training data). Based on this training, generative models may discern intricate patterns and establish meaningful connections within the training data and/or input data. When provided with a prompt, a generative model may create content in the form of text, images, and/or music in accordance with the training data and/or previous input data. The output is dependent on the prompt. In this process, the prompt acts as a directive, conveying the user's intention and setting parameters for the generative model's response. A large language model (LLM) is an example of a generative model. In some examples, the LLM may use a transformer ANN structure. The transformer ANN structure may use attention mechanisms that enable the LLM to process input sequences in a parallel and efficient manner. An attention mechanism allows the model to focus on different parts of the input sequence at different times.

### SUMMARY

In some aspects of the present disclosure, a method includes generating, via a virtual machine, a group of code traces, each code trace of the group of code traces corresponding to a respective algorithm, of a group of algorithms, and a corresponding input. The method further includes fine-tuning a generative model in accordance with the group of code traces. The method also includes receiving, at the fine-tuned generative model, computer programming code. The method further includes generating, via the fine-tuned generative mode, one or more computer programming code statements corresponding to the computer programming code or simulate an expected output of the computer programming code.

Some other aspects of the present disclosure are directed to an apparatus. The apparatus includes means for generating, via a virtual machine, a group of code traces, each code trace of the group of code traces corresponding to a respective algorithm, of a group of algorithms, and a corresponding input. The apparatus further includes means for fine-tuning a generative model in accordance with the group of code traces. The apparatus also includes means for receiving, at the fine-tuned generative model, computer programming code. The apparatus still further includes means for generating, via the fine-tuned generative mode, one or more computer programming code statements corresponding to the computer programming code or simulate an expected output of the computer programming code.

In some other aspects of the present disclosure, a non-transitory computer-readable medium with program code recorded thereon is disclosed. The program code is executed by one or more processors and includes program code to generate, via a virtual machine, a group of code traces, each code trace of the group of code traces corresponding to a respective algorithm, of a group of algorithms, and a corresponding input. The program code also includes program code to fine-tune a generative model in accordance with the group of code traces. The program code further includes program code to receive, at the fine-tuned generative model, computer programming code. The program code still further includes program code to generate, via the fine-tuned generative mode, one or more computer programming code statements corresponding to the computer programming code or simulate an expected output of the computer programming code.

Some other aspects of the present disclosure are directed to an apparatus. The apparatus having one or more processors; and one or more memories coupled with the one or more processors and storing processor-executable code that, when executed by the one or more processors, is configured to cause the apparatus to generate, via a virtual machine, a group of code traces, each code trace of the group of code traces corresponding to a respective algorithm, of a group of algorithms, and a corresponding input. Execution of the processor-executable code further causes the apparatus to fine-tune a generative model in accordance with the group of code traces. Execution of the processor-executable code also causes the apparatus to receive, at the fine-tuned generative model, computer programming code. Execution of the processor-executable code still further causes the apparatus to generate, via the fine-tuned generative mode, one or more computer programming code statements corresponding to the computer programming code or simulate an expected output of the computer programming code.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIG. 2 is a block diagram illustrating an exemplary software architecture that may modularize artificial intelligence (AI) functions, in accordance with various aspects of the present disclosure.

FIG. 3 is a block diagram illustrating an exemplary software architecture that may modularize AI functions.

FIG. 4A is a diagram illustrating an example of a bubble sort (bubble_sort) function, in accordance with various aspects of the present disclosure.

FIG. 4B is a diagram illustrating an example of a code trace of a bubble sort function and an input, in accordance with various aspects of the present disclosure.

FIG. 4C is a diagram illustrating an example of a state trace, in accordance with various aspects of the present disclosure.

FIG. 5A is a diagram illustrating an example of an exchange sort (exchange_sort) function, in accordance with various aspects of the present disclosure.

FIG. 5B is a diagram illustrating an example of a code trace of an exchange sort function and an input, in accordance with various aspects of the present disclosure.

FIG. 5C is a diagram illustrating an example of a state trace, in accordance with various aspects of the present disclosure.

FIG. 6 is a table illustrating an example of a transformation of a program into an interactive session by tracing its execution through a control flow, in accordance with various aspects of the present disclosure.

FIG. 7 is a flow diagram illustrating an example of a process for training a generative model on one or more code traces, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Generative models represent one type of artificial neural network. Specifically, generative models may be an example of a deep neural network. Generative models, which are specified to generate new data, such as text, audio, images, and/or video, may be implemented using deep neural network architectures. These architectures include multiple layers of interconnected neurons, allowing the model to learn complex patterns and generate new data based on a prompt. Examples of deep neural network architectures used for generative models include, but are not limited to, variational autoencoders (VAEs), generative adversarial networks (GANs), and autoregressive models, such as transformers.

In most cases, generative models are trained on extensive datasets of pre-existing content (hereinafter referred to as training data). Based on this training, generative models may discern intricate patterns and establish meaningful connections within the training data and/or input data. When provided with a prompt, a generative model may create content in the form of text, images, and/or music in accordance with the training data and/or previous input data. The output is dependent on the prompt. In this process, the prompt acts as a directive, conveying the user's intention and setting parameters for the generative model's response. A large language model (LLM) is an example of a generative model.

Generative models, such as LLMs, may solve complex problems by executing a sequence of reasoning steps. This capability is available at inference time, based on the training data provided during a training stage. In most cases, the training data includes examples with chain of thoughts (CoTs). However, this chain of thoughts approach may fail due to the propagation of errors or the absence of chain of thoughts training data. The generation of additional training data that encompasses reasoning steps can be costly in terms of time and computing resources. Moreover, if such data is generated using LLMs, the training data may contain reasoning that is either unfaithful or incorrect.

Humans have the ability to write programs to address (e.g., solve) complex problems across a variety of domains. These programs may be unpacked (e.g., unrolled) to obtain a code trace, which provides a step-by-step description of how the program arrived at a solution. The code trace may be similar to a sequence of reasoning steps. For example, given a task of sorting a list of integers, a code trace may indicate how a bubble sort function iterates through and modifies the list of integers step-by-step to obtain the sorted list. As an example, steps of the bubble sort function include: comparing a first element with a second element; swapping the first and second elements if the first element is greater than the second element; comparing the second element with a third element; and so on. These code traces are both faithful and correct.

In most cases, the execution of an arbitrary function may be traced. Various aspects of the present disclosure consider functions that are typically used to teach data structures and algorithms. Still, other types of functions may be considered. Various aspects of the present disclosure create traces of the Python programming language. Still, other types of programming languages may be used. The code traces may include a sequence of interactions with a Python read-eval-print loop (REPL). Such interactions teach the LLM how the Python REPL can be used to solve a given problem.

Various aspects of the present disclosure are directed to a scalable process for generating synthetic training data that captures the step-by-step problem-solving process of any function. In some examples, the training data includes a sequence of Python statements interleaved with the interpreter's outputs. The interpreter's outputs refer to results or responses generated by a Python interpreter when executing the Python statements provided in the code traces. These outputs include any information displayed in the interpreter's interface during the execution of the code, such as, but not limited to, variable values, function outputs, error messages, or any other relevant information. Additionally, in some examples, a new benchmark is introduced to assess the capability of an LLM to solve a problem while interacting with a virtual machine.

Particular aspects of the subject matter described in this disclosure can be implemented to realize one or more of the following potential advantages. In some examples, the described techniques of training and/or fine-tuning a generative model, such as an LLM, on code traces may improve the generative model's ability to generalize across various problem-solving tasks. Generalization refers to applying learned knowledge and skills to new, unseen tasks or scenarios. Additionally, exposure to code traces improves the generative model's understanding of Python mechanics, leading to better performance on coding and reasoning benchmarks, such as, for example, HumanEval, MBPP, GSM8K, and related assessments.

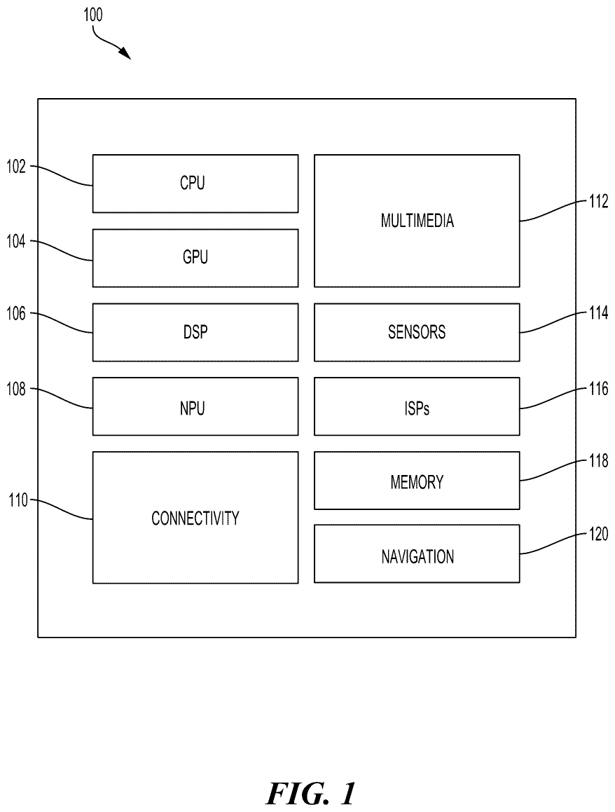

FIG. 1 illustrates an example implementation of a system-on-a-chip (SOC) 100, which may include a central processing unit (CPU) 102 or a multi-core CPU configured for generating one or more code traces and training a generative model on the one or more code traces. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to generate a group of code traces, each code trace of the group of code traces corresponding to a respective function, of a group of functions, and a corresponding input; code to train a generative model on the group of code traces; and code to perform one or more tasks via the trained generative model.

In some aspects, the general-purpose processor 102 may include means for generating a group of code traces, each code trace of the group of code traces corresponding to a respective function, of a group of functions, and a corresponding input; means for training a generative model on the group of code traces; and means for performing one or more tasks via the trained generative model.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

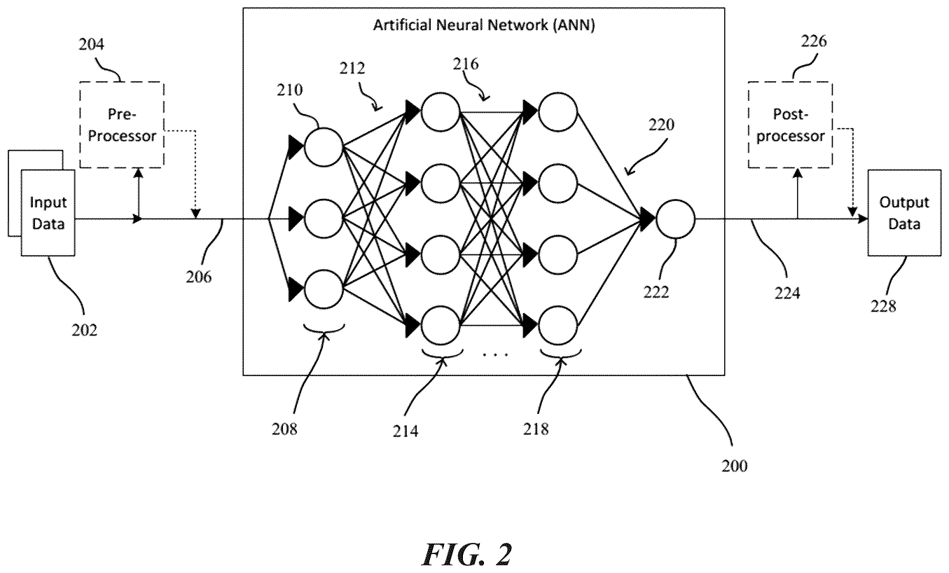

FIG. 2 is an illustrative block diagram of an example machine learning (ML) model represented by an artificial neural network (ANN) 200. The ANN 200 may receive input data 206 which may include one or more bits of data 202, pre-processed data output from pre-processor 204 (optional), or some combination thereof. Here, data 202 may include training data, verification data, application-related data, or the like, based, for example, on the stage of deployment of the ANN 200. A pre-processor 204 may be included within the ANN 200 in some other implementations. The pre-processor 204 may, for example, process all or a portion of the data 202, which may result in some of the data 202 being changed, replaced, deleted, etc. In some implementations, the pre-processor 204 may add additional data to the data 202.

The ANN 200 includes at least one first layer 208 of artificial neurons 210 to process input data 206 and provide resulting first layer data via connections or “edges” such as the edges 212 to at least a portion of at least one second layer 214. The second layer 214 processes data received via the edges 212 and provides second layer output data via the edges 216 to at least a portion of at least one third layer 218. The third layer 218 processes data received via the edges 216 and provides third layer output data via the edges 220 to at least a portion of a final layer 222 including one or more neurons to provide output data 224. All or part of the output data 224 may be further processed in some manner by an optional post-processor 226. Thus, in certain examples, the ANN 200 may provide output data 228 that is based on output data 224, post-processed data output from the post-processor 226, or some combination thereof.

The post-processor 226 may be included within the ANN 200 in some other implementations. The post-processor 226 may, for example, process all or a portion of the output data 224 which may result in the output data 228 being different, at least in part, to the output data 224, as result of data being changed, replaced, deleted, etc. In some implementations, the post-processor 226 may be configured to add additional data to the output data 224. In this example, the second layer 214 and third layer 218 represent intermediate or hidden layers arranged in a hierarchical or other like structure. Although not explicitly shown, there may be one or more further intermediate layers between the second layer 214 and the third layer 218.

The structure and training of artificial neurons 210 in the various layers may be tailored to specific requirements of an application. Within a given layer such as the first layer 208, second layer 214, or third layer 218 of the ANN 200, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of the ANN 200. The weights and biases of the ANN 200 may be adjusted during a training process or during operation of the ANN 200. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may model different types of non-linear relationships. By introducing non-linearity into an ML model, an activation function allows the configuration for the ML model to change in response to identifying or detecting complex patterns and relationships in the input data 206. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as the ANN 200, may be conducted using training data. Training data may include one or more datasets the ANN 200 may use to identify patterns or relationships. Training data may represent various types of information, including written, visual, audio, environmental context, operational properties, etc. During training, the parameters (such as the weights and biases) of artificial neurons 210 may be changed, such as to minimize or otherwise reduce a loss function or a cost function. A training process may repeat multiple times to fine-tune the ANN 200 with each iteration.

Various ANN model structures are available for consideration. For example, in a feed-forward ANN structure, each artificial neuron 210 in layer 214 receives information from the previous layer (such as, one or more artificial neurons 210 in layer 208) and produces information for the next layer (such as, one or more artificial neurons 210 in layer 218). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feed-forward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing, such as text generation. A large language model may be a particularly useful implementation of a transformer ANN structure.

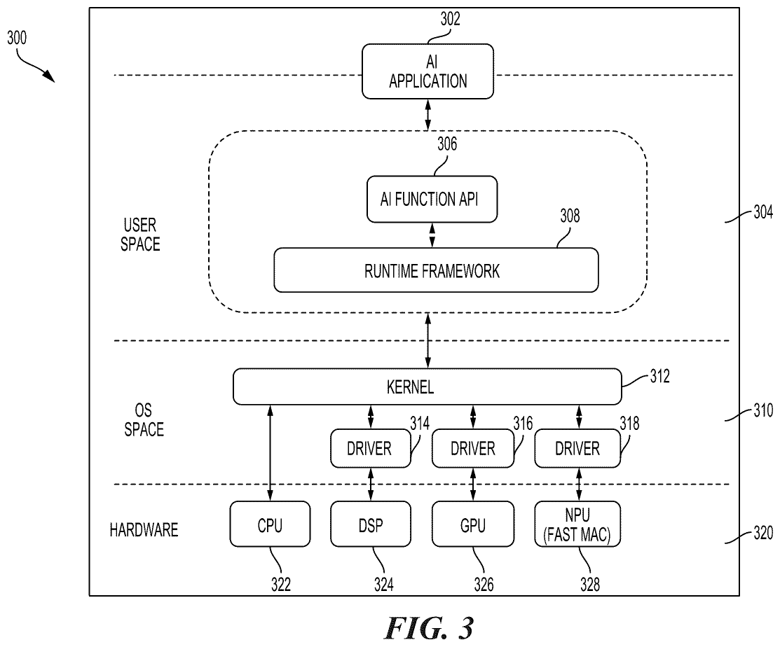

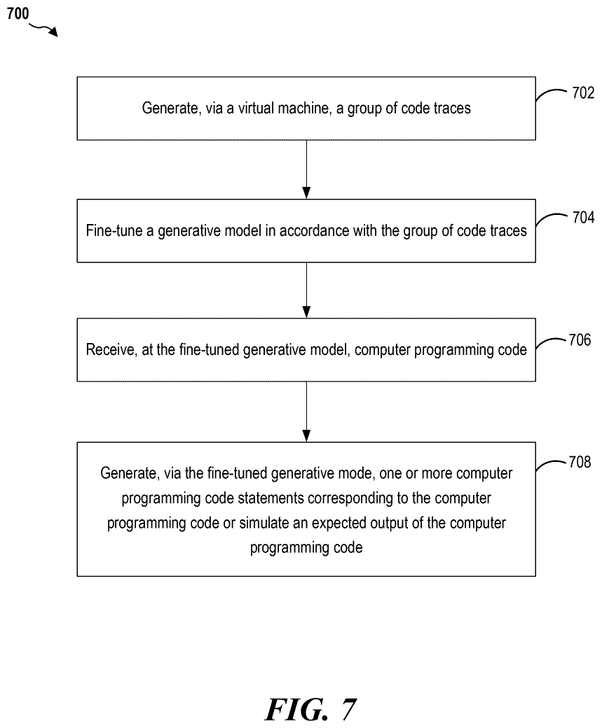

FIG. 3 is a block diagram illustrating an exemplary software architecture 300 that may modularize artificial intelligence (AI) functions. Using the architecture 300, applications may be designed that may cause various processing blocks of an SOC 320 (for example a CPU 322, a DSP 324, a GPU 326 and/or an NPU 328) (which may be similar to the SOC 100 of FIG. 1) to perform one or more operations, such as the operations of the process 700 described with reference to FIG. 7, for an AI application 302, according to aspects of the present disclosure. The architecture 300 may, for example, be included in a computational device, such as a smartphone.

The AI application 302 may be configured to call functions defined in a user space 304 that may, for example, provide for text, video, and/or sound generation. The AI application 302 may make a request to compiled program code associated with a library defined in an AI function application programming interface (API) 306. This request may ultimately rely on the output of a deep neural network configured to provide an inference response based on input, for example.

The run-time engine 308, which may be compiled code of a runtime framework, may be further accessible to the AI application 302. The AI application 302 may cause the run-time engine 308, for example, to request an inference at a particular time interval or triggered by an event detected by the user interface of the AI application 302. When caused to provide an inference response, the run-time engine 308 may in turn send a signal to an operating system in an operating system (OS) space 310, such as a Kernel 312, running on the SOC 320. In some examples, the Kernel 312 may be a LINUX Kernel. The operating system, in turn, may cause non-contiguous attention masks to be processed on the CPU 322, the DSP 324, the GPU 326, the NPU 328, or some combination thereof. The CPU 322 may be accessed directly by the operating system, and other processing blocks may be accessed through a driver, such as a driver 314, 316, or 318 for, respectively, the DSP 324, the GPU 326, or the NPU 328. In the exemplary example, the deep neural network may be configured to run on a combination of processing blocks, such as the CPU 322, the DSP 324, and the GPU 326, or may be run on the NPU 328.

Neural computations, such as those performed by conventional large language models (LLMs), operate in an informal manner by identifying patterns within distributed representations. This pattern-matching approach facilitates reasoning shortcuts and analogical thinking, but it also has the drawback of occasionally producing inaccurate or nonsensical outputs, commonly referred to as hallucinations. In contrast, conventional computations executed by a Turing machine or an equivalent virtual machine (VM) are formal in nature, offering guaranteed outcomes but with less flexibility and adaptability. To leverage the strengths of both paradigms, aspects of the present disclosure are directed to a novel framework that enables neural and conventional computations to interact through a read-eval-print loop (REPL). This interaction allows informal reasoning, driven by the LLM, to guide formal computations.

In some examples, an interpreter directly manipulates data while the LLM oversees the control flow of execution. In some such examples, the LLM uses the VM's evaluation of expressions to determine subsequent actions, while the interpreter's execution of these actions modifies the data, resulting in state transitions within the VM. Accordingly, the LLM may plan ahead, inspect the evolving data, make decisions, and backtrack when necessary.

To train the LLM within this framework, training data may be generated by tracing the execution of various functions (e.g., algorithms). These traces consist of sequences of interactions with a coding interpret, such as a Python interpreter through its REPL, providing a clear example of how functions can be executed step by step. By exposing the LLM to these traces, the LLM may learn how to solve specific problem instances. For example, the LLM may use the Python REPL as a tool. Additionally, in some examples, the VM may be omitted entirely, with the LLM simulating the VM's functions. In such examples, the code traces serve as a training signal, representing sequences of reasoning steps similar to those produced by chain of thought (CoT) prompting.

As discussed, various aspects of the present disclosure enable LLMs to interact directly with a coding language interpreter, such as the Python interpreter via the REPL. This interaction allows for grounded, step-by-step reasoning at a meta-level, facilitated by a scalable data generation technique. By tracing the execution of functions (e.g., algorithms) across diverse inputs, the LLM may be fine-tuned to improve its reasoning capabilities and generalization performance.

Conventional large language models (LLMs) are trained and evaluated on single interactions. This limits an LLM's ability to maintain a cohesive understanding of a task across multiple interactions. For example, an LLM may fail to maintain a cohesive understanding of a task across multiple prompts (e.g., multiple interactions). In such cases, the LLM may lose sight of the overarching goal. This challenge remains unsolved, and most academic benchmarks used to evaluate LLMs are structured around single interactions, where the LLM is given a task, provides a solution, and the accuracy is assessed based on the response to the single task.

Additionally, LLMs often struggle with complex problems that specify multiple reasoning steps to solve. Specifically, LLMs exhibit difficulty in executing sequential reasoning steps necessary for problem-solving. Some solutions aim to elicit this type of reasoning from LLMs. Still, while these solutions may provide reasoning steps and yield correct results, upon closer inspection, the reasoning itself is often flawed, leading to inconsistent performance. Additionally, LLMs sometimes struggle with seemingly simple tasks, such as basic arithmetic operations, such as addition, a task that conventional computer programs effortlessly handle.

Overall, there is considerable room for improvement in LLMs' performance, as evidenced by their relatively high error rates in current academic benchmarks. These challenges may be addressed by training LLMs on data that accurately captures the cognitive processes involved in solving various problems. However, data containing detailed thought processes behind solutions is exceedingly rare, exacerbating the difficulty in enhancing the reasoning capabilities of LLMs.

Efforts to synthetically generate such training data often yield numerous noisy samples. Typically, humans address complex challenges by crafting computer programs, such as simulations, tailored to a specific domain. These programs articulate a precise sequence of operations executed in order to arrive at a solution. As discussed, various aspects of the present disclosure are directed to a scalable process for generating synthetic training data that captures the step-by-step problem-solving process of any function. Such functions are motivated by computer programs written by humans to solve complex problems. In some examples, the training data includes a sequence of Python statements interleaved with the interpreter's outputs. The interpreter's outputs refer to results or responses generated by a Python interpreter when executing the Python statements provided in execution traces, which may also be referred to as code traces (hereinafter used interchangeably). These outputs include any information displayed in the interpreter's interface during the execution of the code, such as, but not limited to, variable values, function outputs, error messages, or any other relevant information.

As discussed, in some examples, a large language model (LLM) interacts with a virtual machine associated with a coding language, such as a Python virtual machine. Various aspects of the present disclosure use Python as an example of the coding language. However, aspects of the present disclosure are not limited to Python. The underlying framework is versatile and can be applied to other programming languages. Python's design prioritizes readability and is often syntactically similar to pseudo-code, making it an ideal choice for conveying the core logic of an algorithm.

In order to fine-tune an LLM, the format of code traces should resemble the type of data that a pre-trained LLM has encountered during its training. For Python, a natural format that satisfies this criterion is the Python interactive session, also referred to as the read-eval-print loop (REPL). In this format, each line of code begins with a prompt>>>and is followed by a line break after the code is entered. The interpreter then executes the code, updating its state, which includes objects in both the global and local namespaces. If the code line produces a result that is not None, the interpreter prints the result on the following line.

This format is intuitive and also widely used in Python documentation, such as in docstrings, and in Python programming tutorials. However, this text format is relatively scarce, and most examples consist of only a few interactions between the programmer and the machine. This scarcity presents a challenge for training the LLM. To address this, aspects of the present disclosure synthetically generate data in this format, so that a sufficient volume of high-quality examples are provided to train the LLM. By focusing on the Python REPL format, aspects of the present disclosure use a structure that is familiar to the LLM, aligning with its prior training data and allowing for more efficient and accurate learning (e.g., fine-tuning).

Synthetic data may be generated by tracing the execution of Python functions that implement respective algorithms. These algorithms include, but are not limited to, Bubble Sort, Exchange Sort, and A* search. Each of these algorithms operates by executing a specific sequence of statements, where each statement is ordered to produces the correct outcome. The tracing process is focused at the function level, such that one or more portions of the Python code are included in the trace and one or more portions are executed. By focusing on function-level tracing, the code that contributes directly to the algorithm's execution may be monitored while excluding background operations that are not essential for the trace.

For example, when a function or method call, such as len (A), is executed, it returns the length of the list A. However, because the internal functions of len( ) do not contribute directly to understanding the algorithm's logic, this operation is not included in the trace. Instead, critical operations that directly influence the flow and logic of the algorithm are traced, such as loops, conditionals, and key function calls that alter the state of the data. This selective tracing keeps the traces concise and focused on the algorithm's core logic, making it easier for the LLM to learn the intended patterns and reasoning steps. Additionally, selective tracing avoids overwhelming the model with unnecessary details that do not contribute to the algorithm's understanding.

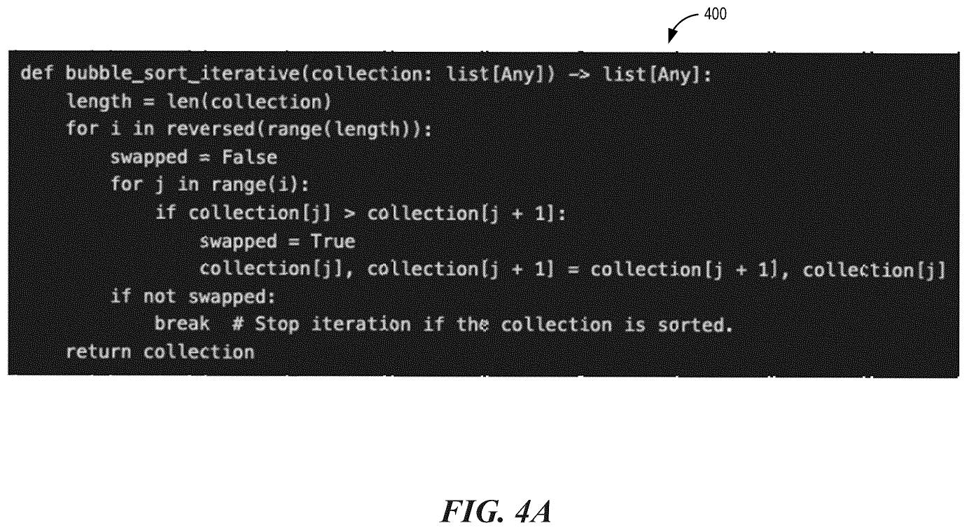

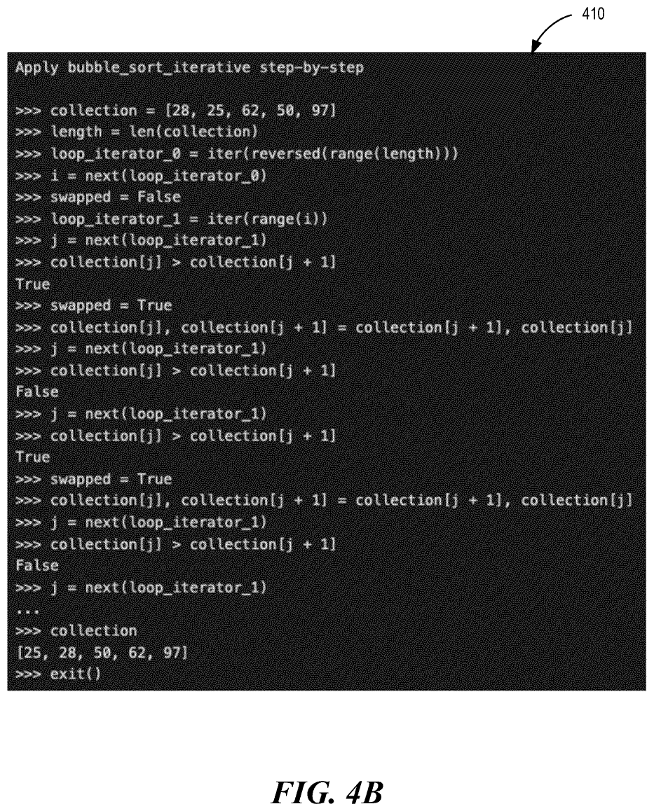

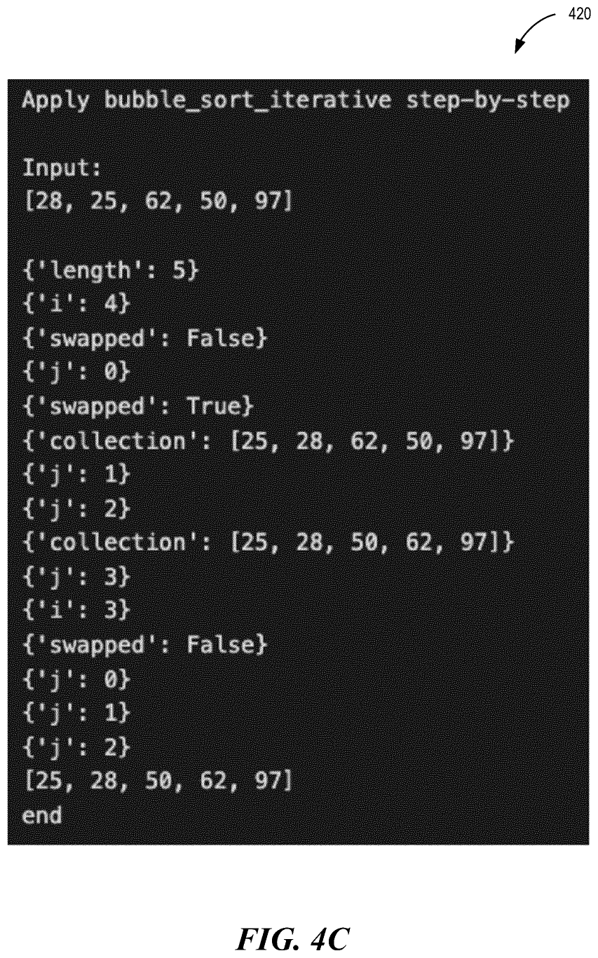

In some examples, a trace may be generated by executing a function, such as a Python function, based on input values. FIG. 4A is a diagram illustrating an example of a bubble sort (bubble_sort) function 400, in accordance with various aspects of the present disclosure. In the example of FIG. 4A, the input to a bubble sort function 400 may be [28, 25, 62, 50, 97]. As shown in the example of FIG. 4A, the execution of the function may be traced line-by-line. The function may be executed by a virtual machine, such as a Python virtual machine.

FIG. 4B is a diagram illustrating an example of a code trace 410 of a bubble sort function and an input, in accordance with various aspects of the present disclosure. The bubble sort function is an example of the bubble sort function 400 described with reference to FIG. 4A, and the input is [28, 25, 62, 50, 97]. Each line of the trace begins with>>>to mimic the Python session.

Tracing the execution of the bubble sort function line-by-line shows how the function processes and sorts the input. In various aspects of the present disclosure, specific formatting may be used to provide an accurate and reproducible code trace. That is, the resulting code trace 410 is considered valid in the sense that the resulting code trace can be reproduced by interacting with Python in a command-line environment.

FIG. 4C is a diagram illustrating an example of a state trace, in accordance with various aspects of the present disclosure. The state trace 420 traces a state of execution of the bubble sort function 400 described with reference to FIG. 4A. In the example of FIG. 4C, objects are traced only when they change following the execution of a line in the bubble sort function 400.

In some cases, objects may have lengthy representations or maintain the same string representation despite changes in value. In such cases, the resulting state trace can become excessively long or redundant. Therefore, in some such cases, the application of state traces to a broader set of functions may be limited.

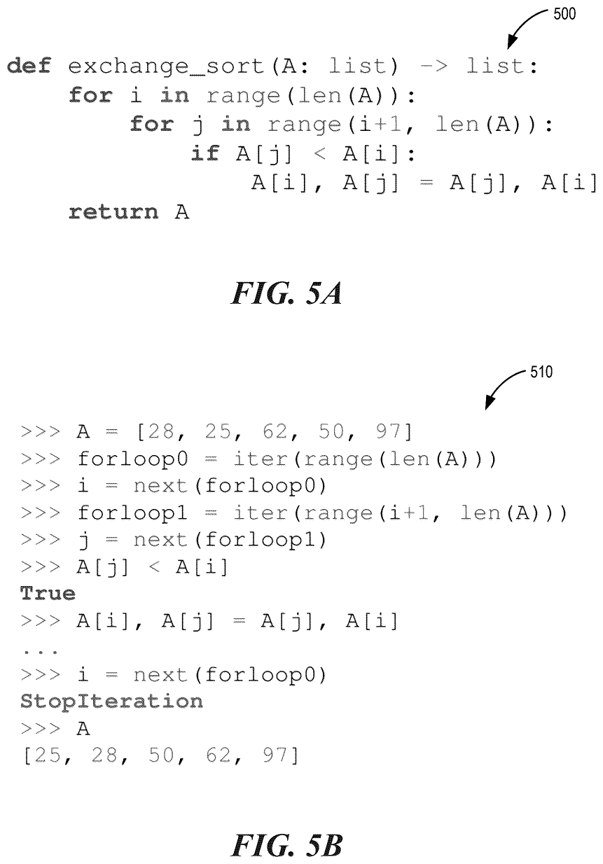

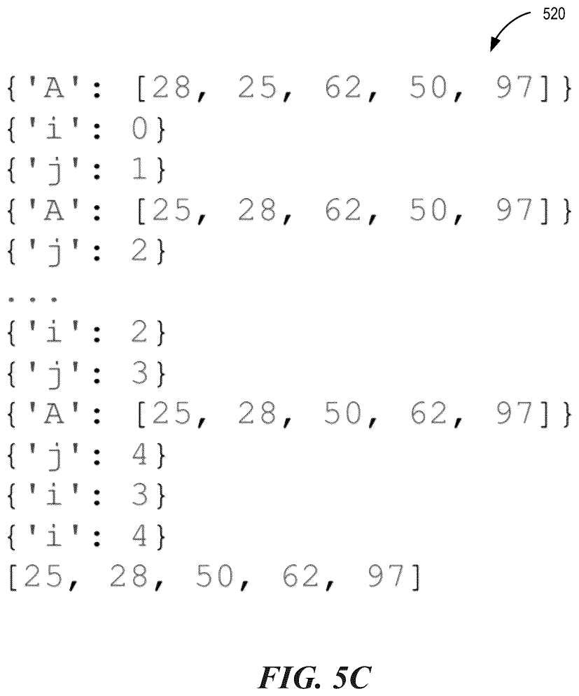

FIG. 5A is a diagram illustrating an example of an exchange sort (exchange_sort) function 500, in accordance with various aspects of the present disclosure. The exchange sort function is a comparison-based sorting technique. The function exchange sort function takes a list A as input and returns a sorted list. The exchange sort function operates by iterating through each element of the list with an outer loop, where the loop variable i ranges from 0 to the length of the list minus one. For each element A[i], the inner loop compares it with every subsequent element A[j], where j starts from i+1 and goes to the last element of the list. If the inner loop finds an element A[j] that is smaller than A[i], the algorithm swaps these two elements. This ensures that the smaller element is placed earlier in the list. The process of comparing and swapping continues until all elements have been appropriately positioned in ascending order. After completing the iterations, the exchange sort function returns the sorted list.

FIG. 5B is a diagram illustrating an example of a code trace 510 of an exchange sort function and an input, in accordance with various aspects of the present disclosure. The exchange sort function is an example of the exchange sort function 500 described with reference to FIG. 5A, and the input is [28, 25, 62, 50, 97]. Each line of the trace begins with>>>to mimic the Python session. The code trace 510 starts with an assignment of the argument to the parameter A. Then, the code trace is expanded by simulating the exchange sort function's execution line-by-line. Lines that do not control execution are directly copied into the code trace, while lines that contain control flow statements are transformed into an interactive session. The purpose of this transformation is to explicitly place the decision of what to run next on the agent that interacts with the interpreter.

Each time a statement is executed in the interactive session, the interpreter might create or update a variable as a result. FIG. 5C is a diagram illustrating an example of a state trace 520, in accordance with various aspects of the present disclosure. The state trace 520 tracks changes to variables as a result of the execution of a statement in the interactive session.

Tracing Python code at the function level provides control over the specific Python code lines to track such that traced functions (e.g., traced lines of code) may be distinguished from functions (e.g., lines of code) executed in the background. Lines of code executed in the background do not appear in the code trace. For example, although executed, the range function shown in the example of FIG. 4A is not included in the code trace shown in the example of FIG. 4B. That is, the range function is an example of a function that is executed in the background.

In Python, statements may be categorized into normal statements and control flow statements. A normal statement, such as assigning a value to a variable such as “length=len(collection),” is straightforwardly copied into the code trace. That is, normal statements are directly copied into the code trace. However, control flow statements, such as “for j in range (i),” affect a sequence of statement execution. Thus, control flow statements may not be copied verbatim into the code trace without additional consideration. Rather, control flow statements may be reformulated into a self-contained Python statement so that the full code trace is valid.

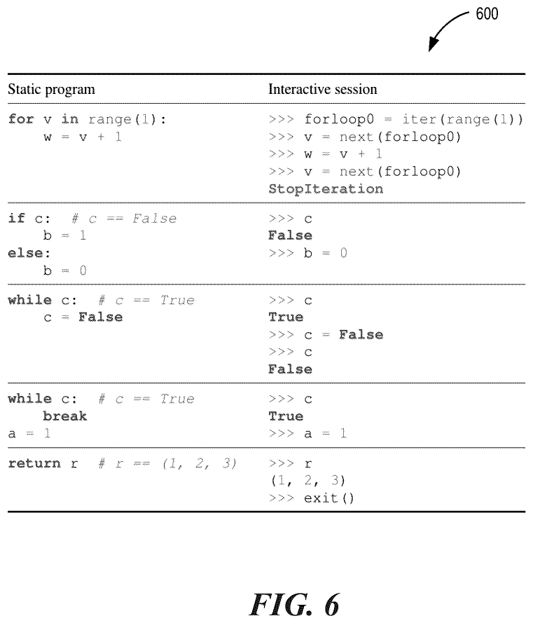

FIG. 6 is a table 600 illustrating an example of a transformation of a program into an interactive session by tracing its execution through a control flow, in accordance with various aspects of the present disclosure. The table 600 illustrates a comparison between a static Python program and its corresponding execution in an interactive Python session. The comparison demonstrate how different programming constructs, such as loops, conditionals, and return statements, behave when executed in real-time.

In the first row, a “for” loop iterates once over a range of one, assigning v the value 0 and then calculating w as v+1, resulting in w=1. In the interactive session, this loop is manually broken down into its constituent parts: an iterator is created, v is assigned using next, and after one iteration, a StopIteration exception is raised, indicating the loop's natural termination.

The second row involves an “if-else” statement that checks the value of c. Since c is False, the else branch is executed, setting b to 0. The interactive session confirms this logic by showing the evaluation of c and the resulting assignment of b. In the third row, a “while” loop continues as long as c is True. Inside the loop, c is set to False, which causes the loop to terminate after one iteration. The interactive session mirrors this process, confirming the initial condition and the subsequent update to c. The fourth row introduces a “while” loop with a break statement. The loop checks if c is True and immediately exits the loop, after which a is set to 1. The interactive session reflects this logic by confirming the condition of c and assigning a accordingly. Finally, the fifth row shows a return statement that would return the value of r, which is (1, 2, 3). The interactive session verifies the value of r and then concludes with an exit ( ) command.

Control flow statements play a role in determining the sequence in which a program's code is executed. Specifically, control flow statements dictate how the execution proceeds, either by making decisions, repeating certain blocks of code, or altering the standard top-to-bottom execution order. A compiled bytecode generated from the source code may be used to identify control flow statements. Specifically, a line of code is classified as a control flow statement if and only if its compiled bytecode includes instructions that alter the bytecode pointer, which directs the flow of execution within the program. Examples of such bytecode instructions include POP_JUMP_IF_FALSE and JUMP_ABSOLUTE.

These bytecode instructions indicate branching (as in conditional statements), looping, or jumping to different parts of the code, which are functions that correspond to control flow mechanisms. For instance, POP_JUMP_IF_FALSE may be used in “if” statements to determine whether to skip a block of code, while JUMP_ABSOLUTE can be used in loops to repeat certain operations.

A set of transformation rules may be specified to translate these control flow statements into interactions that can be executed by an interpreter. These rules systematically convert the high-level control flow logic of the source code into a series of lower-level instructions that the interpreter can process in an interactive session. This transformation is essential for allowing an interpreter to mimic the behavior of control flow statements during execution, enabling more granular analysis and testing of code behavior.

By implementing these transformation rules, complex control flow may be broken down into manageable, step-by-step interactions with the interpreter. This allows for a deeper understanding of how control flow statements operate and ensures that the execution flow can be accurately replicated in an interactive environment, which is particularly useful for debugging, teaching, and analyzing program behavior.

In some examples, for “if . . . (else . . . )” statements, the condition is added to the trace, followed by its corresponding value (e.g., True) in the subsequent line. This is the same format as it would appear when executing the expression in a Python session. For conditional statements, the condition is passed directly to the interpreter as an expression. The interpreter evaluates the expression and prints the result in the following line. Unlike the conventional behavior of the Python interpreter, the condition is not explicitly cast to a boolean. Python allows non-boolean values to be used as conditions, which are then evaluated according to Python's truthiness rules. For example, if the variable c references the list [‘a’, ‘b’], the variable c serves as a valid condition that evaluates to True. Instead of displaying the boolean result, the original list is shown in the output. The body of the conditional statement only appears in the interactive session if the condition evaluates to True and the body is executed.

Additionally, for “while” loops, the condition is included each time the condition is evaluated (e.g., checked). The value of the condition is followed in the next line of the code trace. Similar to if-else statements, the condition is exposed as an expression in the interactive session. At the beginning of each iteration in the loop, the condition is evaluated, and the body of the loop is repeated as long as the condition is true.

Furthermore, in the case of “for” loops, such as “for . . . in . . . ,” a new iterator object is created by evaluating the expression through which it loops. In the example of FIG. 6, the iterator is a variable “forloop0.” This iterator object is assigned to a new variable, and then the built-in function “next” is called on the iterator. To handle nested for-loops, a numerical suffix is appended to each loop variable, incrementing the number for each inner loop. At the beginning of each iteration, the next item in the sequence is assigned to the loop variable. This process continues until there are no more items left in the sequence, at which point a StopIteration exception is raised. This exception is then captured and recorded in the code trace as a response from the interpreter, ensuring that the entire loop execution, including its termination, is accurately documented. The “next” function is a function that is used to retrieve the next item from an iterator. When called, it advances the iterator to the next element and returns that element.

In some other examples, a state of execution may be traced. That is, instead of retaining a complete copy of the state after every change, objects are traced only when they change following the execution of a line in the function. Additionally, in some examples, a return value is added as an expression to the code trace and concludes the interactive session with a call to the exit function.

In some examples, to improve the training or fine-tuning of an LLM for code execution, multiple samples of code traces are generated for each function by running the function with various input values. Each sample begins with a prompt that describes the algorithm's behavior and specifies the input values used. These samples are then used to train the LLM on a standard next-token prediction objective. Through this process, the LLM learns to fulfill dual roles: first, the LLM acts as a “neural computer,” deciding which code to execute next, and second, the LLM acts as a “conventional computer,” executing the code and reporting any resulting output.

Empirical observations reveal that accurately simulating code execution poses significant challenges for the LLM, especially when it comes to generalizing across different scenarios. For example, executing the results of complex operations is particularly challenging for the LLM because the LLM must implicitly track the state of a machine throughout the process. Conventional LLMs do not track the state of the machine throughout the process. For example, in the case of the exchange sort function, the list A only appears in its final form at the end of the trace, leaving the intermediate states of the list hidden from the LLM's direct observation. For the LLM to accurately predict the final result, its internal representations of the intermediate steps must effectively capture the changes to the list throughout the execution.

To address this challenge, quizzes are introduced as an auxiliary task aimed at improving the LLM's representation learning. During the code trace, a variable is randomly added as an expression at various points. This forces the LLM to be prepared at any step to predict the value of some variable in the local namespace. This auxiliary task helps the LLM develop a more nuanced understanding of how variables change throughout the execution, thereby improving its ability to track state changes and make accurate predictions.

Additionally, or alternatively, the LLM may be trained on code traces from multiple different algorithms. In this scenario, the LLM learns to predict the interpreter's response across a variety of variable names, sequences of operations, and code trace lengths. This variability introduces complexity but also offers an opportunity for the LLM to improve its generalization capabilities.

By exposing the LLM to diverse algorithms, the LLM may better generalize its predictions for interpreter responses across different contexts. This broader training approach encourages the LLM to develop a more flexible understanding of how different algorithms operate, which in turn enhances its ability to handle new and unseen code traces.

In summary, by generating diverse samples and introducing auxiliary tasks, such as quizzes, the LLM is trained to better understand and simulate code execution. These methods address some of the inherent challenges in predicting code execution, particularly in maintaining accurate state representations and generalizing across different algorithms. This multi-faceted approach aims to improve the LLM's overall performance in simulating the interpreter and executing code traces.

The approach of generating training data from code traces is scalable, particularly in addressing the challenge regarding the scarcity of training data encompassing both solutions and the underlying thought processes. Unlike attempting to generate such data directly using an LLM, aspects of the present disclosure produce faithful outputs. A faithful output is an example of an output wherein the reasoning steps are correct and align consistently with the overall solution, ensuring the correctness of the generated content.

In some cases, an LLM may be trained to generate code. Typically, in code generation, LLMs generate code character by character, or token by token, in a single shot, proceeding linearly from start to finish. One potential effect that we anticipate contrasts with code generation practices. In contrast, various aspects of the present disclosure are directed to training the LLM to solve a problem dynamically, rather than producing a static code solution. Traditional static functions, generated to tackle specific problems, may lack adaptability and can inadvertently introduce errors. However, by using code traces to train the LLM, the LLM model is trained to adapt and respond to errors as they arise. Therefore, the code generated by the LLM is not static.

Additionally, aspects of the present disclosure may generate a large-scale synthetic dataset that is similar to procedural behavior specified to solve various problems. This dataset may be used to train and evaluate LLMs across different problem-solving scenarios, thereby improving the generalization capabilities of LLMs. For example, an LLM's ability to solve unknown problems, such as sorting in reverse or navigating mazes, may be improved as a result of the training. Additionally, training on the synthetic dataset allows for the generalization to more complex instances of the same problem type, such as sorting longer lists.

Additionally, by using the synthetic dataset to train an LLM, the LLM may consider problem-specific characteristics during problem-solving, akin to human problem-solving strategies. This type of training promotes adaptive problem-solving approaches. For example, for sorting functions, such as bubble sort, the choice of function can vary based on the initial state of the input list. In such an example, if the list is randomly shuffled, a quick sort tends to be efficient, whereas if the input list is already sorted, bubble sort may be more suitable. In conventional models (e.g., LLMs), a function may be selected based on the characteristics of the instance being processed. This is referred to as the portfolio method. In contrast, an LLM trained in accordance with various aspects of the present disclosure may dynamically adapt during sorting. That is, by observing the current state of the list as it is being sorted, the LLM may learn to combine different strategies or components from various functions, thereby improving the sorting processes.

Additionally, in some examples, the LLM may be trained to interact with the Python environment or another coding environment. By learning this capability, the LLM may interact with the coding environment to execute tasks (e.g., functions) such as, but not limited to, bubble sort, quick sort, or other functions. In some cases, the LLM may generalize to unfamiliar scenarios. In such cases, the LLM may use its understanding of the coding environment (e.g., Python environment) to perform one or more unfamiliar tasks in the coding environment.

Additionally, by interacting step-by-step with the Python environment, the LLM may be quizzed. For example, the model may be asked about the current state of the Python virtual machine, or another virtual machine, after executing one or more lines of code. This includes querying the values of variables or the current state of the data structure being manipulated. Training the LLM on how to simulate the Python environment is useful for various code generation tasks. For example, when attempting to generate code, the LLM may initially make errors, but the LLM's understanding of the Python environment could assist in refining its outputs over subsequent iterations. Finally, in some cases, the LLM may be trained to correct generated Python functions.

Accordingly, in various aspects of the present disclosure, the LLM may develop general problem-solving skills, such that the LLM may generalize beyond specific training scenarios across various dimensions. For example, the LLM may be adapted to solve problems that are different from training examples. Furthermore, the LLM may handle instance complexity, as evidenced by a capacity for length generalization. Furthermore, in contrast to conventional computers that process data indiscriminately, the trained LLMs may be sensitive to the specifics of the problem instance, tailoring their approach based on the data's characteristics. Furthermore, the trained LLM may use Python not merely as a programming language but as a tool for problem-solving. Finally, the trained LLM may be used for code generation, with a focus on grounding in the semantics of the generated code, such that outputs are not only syntactically correct but also meaningful and contextually appropriate.

As discussed, aspects of the present disclosure are not limited to generating code traces from Python functions. Other coding languages are contemplated.

In summary, various aspects of the present disclosure are directed to training an LLM. Specifically, fine-tuning a pre-trained LLM. Low-rank adaptation (LoRA) may be used for the fine-tuning process. LoRA is particularly advantageous as it reduces the computational resources specified for fine-tuning large models. After fine-tuning the pre-trained model, a substantial number of sequences are generated. These sequences vary in structure. The sequences may correspond to code traces. The core of the training process involves having the LLM predict the next token in a sequence, given a specific prefix.

Once the model has been fine-tuned, it gains the capability to perform at least two primary functions. At a high level, the first function is the ability to predict the next code statement that should be executed. This means the model can autonomously determine the logical sequence of code that follows, which is useful in simulating programming tasks.

The second function involves predicting an environment's response. That is, the fine-tuned LLM may simulate the expected response that would typically come from the interpreter. In most cases, when code is executed in a Python interpreter, the interpreter provides output, such as print statements or results from executed commands. In accordance with various aspects of the present disclosure, the LLM is trained to generate the next line of code and simulate the expected response that would typically come from the interpreter. This allows the model to mimic the interaction between a programmer and the Python environment more accurately.

Additionally, or alternatively, an actual Python interpreter may be used to generate the correct output. This approach ensures that even if the model's simulation isn't entirely accurate, the overall process remains reliable by leveraging the interpreter when necessary. This dual approach-where the model predicts code and attempts to simulate the interpreter's response, with the option to rely on the actual interpreter-provides flexibility and enhances the robustness of the system.

FIG. 7 is a flow diagram illustrating an example of a process 700 for training a generative model on one or more code traces, in accordance with various aspects of the present disclosure. The process 700 may be performed by one or more processors such as the CPU (e.g., 102, 322), GPU (e.g., 104, 326), and/or other processing unit (e.g., DSP 324, NPU 328), for example. As shown in the example of FIG. 7, the process 700 may begin at block 702 by generating, via a virtual machine, a group of code traces. Each code trace of the group of code traces corresponds to a respective algorithm, of a group of algorithms, and a corresponding input. At block 704, the process 700 fine-tunes a generative model in accordance with the group of code traces. At block 706, the process 700 receives, at the fine-tuned generative model, computer programming code. At block 708, the process 700 generates, via the fine-tuned generative mode, one or more computer programming code statements corresponding to the computer programming code or simulate an expected output of the computer programming code.

Implementation examples are described in the following numbered clauses:

Clause 1. A method comprising: generating, via a virtual machine, a group of code traces, each code trace of the group of code traces corresponding to a respective algorithm, of a group of algorithms, and a corresponding input; fine-tuning a generative model in accordance with the group of code traces; receiving, at the fine-tuned generative model, computer programming code; and generating, via the fine-tuned generative mode, one or more computer programming code statements corresponding to the computer programming code or simulate an expected output of the computer programming code.

Clause 2. The method of Clause 1, wherein the group of algorithms are Python algorithms.

Clause 3. The method of Clause 2, wherein the virtual machine is a Python virtual machine.

Clause 4. The method of any one of Clauses 1-3, wherein the generative model is a large language model (LLM).

Clause 5. The method of any one of Clauses 1-4, wherein the generative model is fine-tuned to generate sequences corresponding to the code trace.

Clause 6. The method of any one of Clauses 1-5, wherein each code trace traces the respective algorithm at a function level.

Clause 7. The method of any one of Clauses 1-6, wherein fine-tuned generative model interacts with an interpreter associated with the computer programming code.

Clause 8. An apparatus comprising one or more processors, one or more memories coupled with the one or more processors, and instructions stored in the one or more memories and operable, when executed by the one or more processors to cause the apparatus to perform any one of Clauses 1 through 7.

Clause 9. An apparatus comprising at least one means for performing any one of Clauses 1 through 7.

Clause 10. A computer program comprising code for causing an apparatus to perform any one of Clauses 1 through 7.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method comprising:
generating, via a virtual machine, a group of code traces, each code trace of the group of code traces corresponding to a respective algorithm, of a group of algorithms, and a corresponding input;
fine-tuning a generative model in accordance with the group of code traces;
receiving, at the fine-tuned generative model, computer programming code; and
generating, via the fine-tuned generative mode, one or more computer programming code statements corresponding to the computer programming code or simulate an expected output of the computer programming code.

2. The method of claim 1, wherein the group of algorithms are Python algorithms.

3. The method of claim 2, wherein the virtual machine is a Python virtual machine.

4. The method of claim 1, wherein the generative model is a large language model (LLM).

5. The method of claim 1, wherein the generative model is fine-tuned to generate sequences corresponding to the code trace.

6. The method of claim 1, wherein each code trace traces the respective algorithm at a function level.

7. The method of claim 1, wherein fine-tuned generative model interacts with an interpreter associated with the computer programming code.

8. An apparatus, comprising:
one or more processors; and
one or more memories coupled with the one or more processors and storing processor-executable code that, when executed by the one or more processors, is configured to cause the apparatus to:
generate, via a virtual machine, a group of code traces, each code trace of the group of code traces corresponding to a respective algorithm, of a group of algorithms, and a corresponding input;
fine-tune a generative model in accordance with the group of code traces;
receive, at the fine-tuned generative model, computer programming code; and
generate, via the fine-tuned generative mode, one or more computer programming code statements corresponding to the computer programming code or simulate an expected output of the computer programming code.

9. The apparatus of claim 8, wherein the group of algorithms are Python algorithms.

10. The apparatus of claim 9, wherein the virtual machine is a Python virtual machine.

11. The apparatus of claim 8, wherein the generative model is a large language model (LLM).

12. The apparatus of claim 8, wherein the generative model is fine-tuned to generate sequences corresponding to the code trace.

13. The apparatus of claim 8, wherein each code trace traces the respective algorithm at a function level.

14. The apparatus of claim 8, wherein fine-tuned generative model interacts with an interpreter associated with the computer programming code.

15. A non-transitory computer-readable medium having program code recorded thereon, the program code executed by one or more processors and comprising:
program code to generate, via a virtual machine, a group of code traces, each code trace of the group of code traces corresponding to a respective algorithm, of a group of algorithms, and a corresponding input;
program code to fine-tune a generative model in accordance with the group of code traces;
program code to receive, at the fine-tuned generative model, computer programming code; and
program code to generate, via the fine-tuned generative mode, one or more computer programming code statements corresponding to the computer programming code or simulate an expected output of the computer programming code.

16. The non-transitory computer-readable medium of claim 15, wherein the group of algorithms are Python algorithms.

17. The non-transitory computer-readable medium of claim 16, wherein the virtual machine is a Python virtual machine.

18. The non-transitory computer-readable medium of claim 15, wherein the generative model is a large language model (LLM).

19. The non-transitory computer-readable medium of claim 15, wherein the generative model is fine-tuned to generate sequences corresponding to the code trace.

20. The non-transitory computer-readable medium of claim 15, wherein each code trace traces the respective algorithm at a function level.
